(19) United States
(12) Patent Application Publication
(10) Pub. No.: US 2026/0019516 A1
(43) Pub. Date: Jan. 15, 2026

(54) INFORMATION PROCESSING APPARATUS, INFORMATION PROCESSING SYSTEM, AND METHOD

(71) Applicant: TOSHIBA TEC KABUSHIKI KAISHA, Tokyo (JP)

(72) Inventors: Koji NAGAI, Ota Tokyo (JP); Koji ENDO, Gotemba Shizuoka (JP); Takahiro SASAKI, Sunto Shizuoka (JP); Kai TSUCHIZAWA, Shinagawa Tokyo (JP)

(73) Assignee: TOSHIBA TEC KABUSHIKI KAISHA, Tokyo (JP)

(21) Appl. No.: 19/260,152

(22) Filed: Jul. 3, 2025

(30) Foreign Application Priority Data
Jul. 10, 2024 (JP) 2024-111015

(51) Int. Cl. H04N 1/00

(52) U.S. Cl. CPC H04N 1/00769; H04N 1/00798

(57) ABSTRACT

According to one embodiment, an information processing apparatus can include an acquirer, a reader, a comparer, and a controller. The acquirer can obtain a target file. The reader can read information related to the target file from the target file. The comparer can compare information related to at least one executed file for which a workflow was executed on stored in a storage with the information related to the target file. The controller can control the workflow for the target file based on the comparison result.

### CROSS-REFERENCE TO RELATED APPLICATION

This application is based upon and claims the benefit of priority from Japanese Patent Application No. 2024-111015, filed on Jul. 10, 2024, the entire contents of which are incorporated herein by reference.

### FIELD

Embodiments described herein relate generally to an information processing apparatus, an information processing system, and a method.

### BACKGROUND

A workflow for automatically executing a series of processes, such as tasks or processes, on an electronic file can include, for example, a multi-function peripheral storing an electronic file indicating (e.g., including, etc.) a form in a predetermined storage location by scanning the form using a scanning function. In response to the electronic file being stored in the predetermined storage location, the system can detect the electronic file. The system can select an appropriate workflow from a plurality of pre-set workflows based on information associated with the detected electronic file. The system can execute the selected workflow for the electronic file.

In response to the system executing the workflow on the electronic file indicating the form, the user can cause the same form to be scanned again on the multi-function peripheral. In this case, the multi-function peripheral can store the electronic file having the same contents as the electronic file in which the workflow was executed in the predetermined storage location again. In response to the electronic file indicating the same form being stored in the predetermined storage location, the system can execute the workflow on the electronic file indicating the same form.

In response to the same content workflow being executed multiple times for the electronic file indicating the same form, there is a possibility that unnecessary processing or cost may be incurred. For example, in response to a certain cost being incurred for each execution of a workflow, multiple payments are incurred where originally only one payment was incurred.

### DESCRIPTION OF THE DRAWINGS

FIG. 1 is a block diagram illustrating a schematic example of the configuration of an information processing system according to an embodiment;

FIG. 2 is a block diagram illustrating a schematic example of the configuration of an information processing apparatus;

FIG. 3 is a block diagram illustrating a schematic example of the configuration of a multi-function peripheral;

FIG. 4 is a diagram illustrating a data structure of data stored in an execution information storage area;

FIG. 5 is a sequence diagram illustrating a registration process of a storage location; and

FIG. 6 is a flowchart illustrating control of a workflow.

### DETAILED DESCRIPTION

Embodiments of the present disclosure provide a technique that enables mitigation of unnecessary workflow execution.

In general, according to at least one embodiment, an information processing apparatus can include an acquisition unit (e.g., an acquire, etc.), a reading unit (e.g., a reader, etc.), a comparison unit (e.g., a comparer, etc.), and a control unit (e.g., a controller, etc.). The acquisition unit, the reading unit, the comparison unit, and the control unit can be included in one or more processors. The acquisition unit can obtain a target file. The reading unit can read information related to the target file from the target file. The comparison unit can compare information related to at least one executed file for which a first workflow was executed on stored in a storage with the information related to the target file. The control unit can control the second workflow for the target file based on the comparison result.

Some embodiments will be described below with reference to the drawings. Note that each drawing used in the description of the following embodiments may change the scale of each part as appropriate. Also, each drawing used in the description of the following embodiments may omit the configuration for the purpose of description.

### Embodiments

### Configuration Example

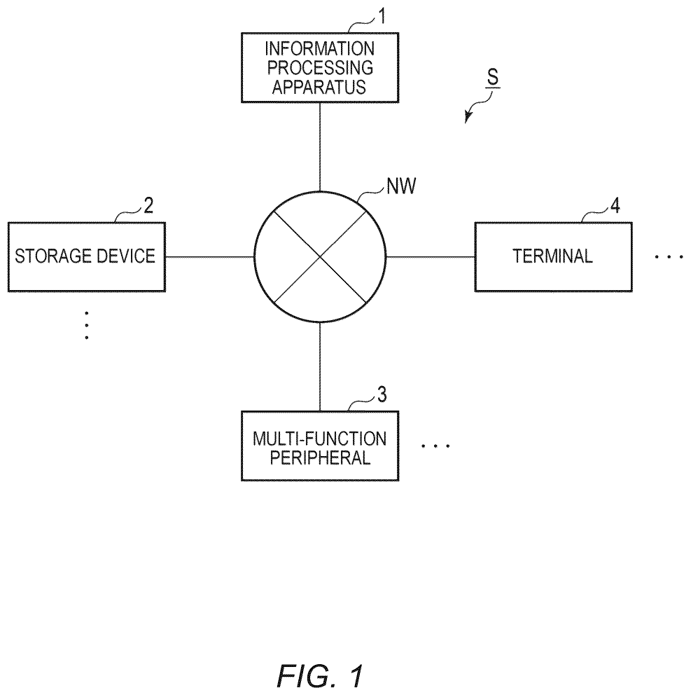

FIG. 1 is a block diagram illustrating a schematic example of the configuration of an information processing system S.

The information processing system S can be a system for controlling a workflow of an electronic file.

The electronic file can be any digitized file. An electronic file can be an electronic file indicating (e.g., including, etc.) a form, but is not limited thereto. For example, the forms may be an invoice, or an order, but are not limited thereto.

An electronic file can be or include image data generated by scanning a medium such as paper with a multi-function peripheral 3, but is not limited thereto. The electronic file can be data including text data created by an application, such as document creation at a terminal 4.

A workflow can be a series of processes along a defined flow. For example, a workflow can be a series of processes that are executed automatically. The sequence of processes can include at least one of one or more tasks or one or more processes. In response to the electronic file being an electronic file indicating an invoice, the workflow may be a series of processes for providing the system processing the invoice with one or both of the electronic file and the information read from the electronic file. In response to the electronic file being an electronic file indicating an order, the workflow may be a series of processes for providing the system processing the order with one or both of the electronic file and the information read from the electronic file.

The information processing system S can include an information processing apparatus 1, a plurality of storage devices 2, a plurality of multi-function peripherals 3, and a plurality of terminals 4. The information processing apparatus 1, the plurality of storage devices 2, the plurality of multi-function peripherals 3, and the plurality of terminals 4 can be communicably connected to each other via a network NW. The network NW can include one or more networks, such as the Internet, a cellular network, and a LAN (Local Area Network). The LAN may be a wireless LAN or a wired LAN. The information processing system S may include one storage device 2, rather than multiple units. The information processing system S may include one multi-function peripheral 3, rather than multiple units. The information processing system S may include one terminal 4, rather than multiple units. The information processing system S can be an example of an information processing system including at least two devices.

The information processing apparatus 1 can be an apparatus for controlling a workflow. For example, the information processing apparatus 1 can be a server. The information processing apparatus 1 can be described as a server on a cloud, but is not limited thereto. The information processing apparatus 1 may be a server installed in the company.

The storage device 2 can be a device for storing data. The storage device 2 can include an auxiliary storage device for storing data. For example, the auxiliary storage device can include an HDD (Hard Disk Drive). The auxiliary storage device may include a semiconductor storage medium such as an SSD (Solid State Drive) in addition to or in place of the HDD. The storage device 2 can be described as a server on a cloud, but is not limited thereto. The storage device 2 may be a server installed in the company. The auxiliary storage device of the storage device 2 can store one or more electronic files that are subject to workflow control. Hereinafter, the electronic file that is subject to workflow control can also be referred to as a target file.

The multi-function peripheral 3 can be a digital multi-function peripheral for comprehensively utilizing the functions of various office equipment. The multi-function peripheral 3 can have a scanning function that generates image data of a medium by scanning the medium. The multi-function peripheral 3 can have a function of storing image data generated by the scanning function as a target file in the storage device 2. The multi-function peripheral 3 can have a function of printing based on image data generated by the scanning function or data transmitted from the terminal 4. For example, the multi-function peripheral 3 can be an MFP (Multifunction Peripheral).

The terminal 4 can be a device that processes information. The terminal 4 can create an electronic file including text data by an application, such as document creation. For example, the terminal 4 is a PC (Personal Computer), a tablet terminal, or a smartphone, but is not limited thereto.

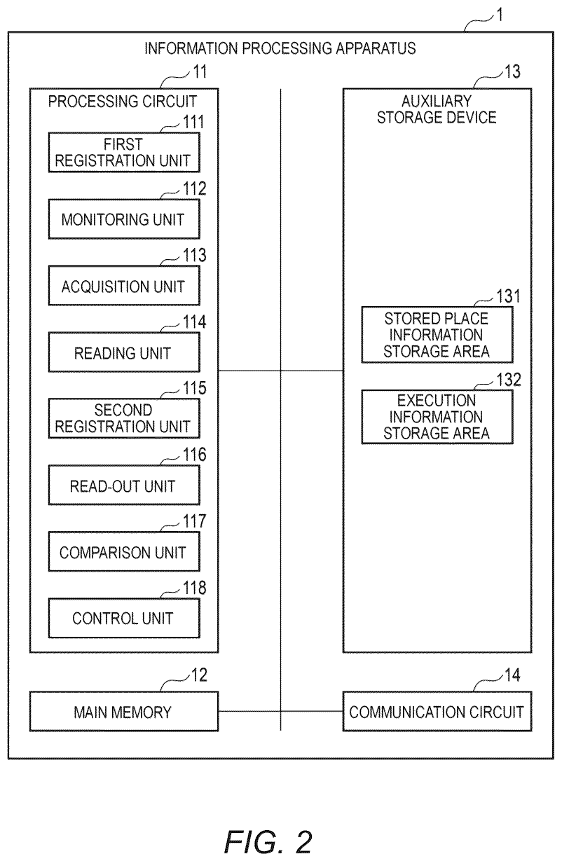

FIG. 2 is a block diagram illustrating a schematic example of the configuration of the information processing apparatus 1.

The information processing apparatus 1 can include a processing circuit 11 (e.g., processor, etc.), a main memory 12, an auxiliary storage device 13, and a communication circuit 14. The processing circuit 11, the main memory 12, the auxiliary storage device 13, and the communication circuit 14 can be connected to each other to enable signal input and output.

The processing circuit 11 can correspond to a central portion of the information processing apparatus 1. The processing circuit 11 can be a component that constitutes a computer of the information processing apparatus 1. The processing circuit 11 can include one or more circuits that execute a plurality of processes with a plurality of functions. For example, the circuit can be a processor, an ASIC (Application Specific Integrated Circuit), or an FPGA (field-Programmable Gate Array), but is not limited thereto. For example, the processor can be a CPU (Central Processing Unit) or a GPU (Graphics Processing Unit), but is not limited thereto. The processing circuit 11 can load a program stored in the main memory 12 or the auxiliary storage device 13 into the main memory 12. The processing circuit 11 can make various processes executable by executing a program loaded in the main memory 12.

The main memory 12 can correspond to a main storage portion of the information processing apparatus 1. The main memory 12 can be a component that constitutes a computer of the information processing apparatus 1. The main memory 12 can include a non-volatile memory region and a volatile memory region. The main memory 12 can store an operating system or program in a non-volatile memory region. The main memory 12 can use a volatile memory region as a work area where data can be rewritten as appropriate by the processing circuit 11. For example, the main memory 12 can include a ROM (Read Only Memory) as a non-volatile memory region. For example, the main memory 12 can include a RAM (Random Access Memory) as a volatile memory region.

The auxiliary storage device 13 can correspond to an auxiliary storage portion of the information processing apparatus 1. The auxiliary storage device 13 can include one or more storage devices. The auxiliary storage device 13 can store the program described above, data used by the processing circuit 11 to perform various processes, and data generated by processing in the processing circuit 11. The auxiliary storage device 13 can be an example of a storage unit (e.g., storage) of the information processing apparatus 1.

The auxiliary storage device 13 can include a storage location information storage area 131 that stores storage location information for each storage location. The storage location information storage area 131 can be an example of a database that stores storage location information for each storage location. The database that stores the storage location information for each storage location can be an example of a storage unit that stores the storage location information for each storage location. Storing the storage location information can indicate that the storage location information is registered.

The storage location can be a storage location set for an auxiliary storage device of any of the storage devices 2 among the plurality of storage devices 2. For example, the storage location can be a folder. The storage location information can be the information indicating the storage location of the target file.

The storage location may be different depending on the type of form. For example, the storage location of the target file indicating an invoice can be different from the storage location of the target file indicating an order. The storage location may be different depending on the issuer of the form. For example, the storage location of the target file indicating an invoice whose issuer is Company A can be different from the storage location of the target file indicating an invoice whose issuer is Company B.

The auxiliary storage device 13 can include an execution information storage area 132 that stores execution information for each target file in which the workflow was executed. Hereinafter, the target file in which the workflow was executed can also be referred to as an executed file. The execution information storage area 132 can be an example of a database that stores execution information for each executed file. The database that stores the execution information for each executed file can be an example of a storage unit that stores the execution information for each executed file. Storing the execution information can indicate that the execution information is registered.

The execution information can be information related to a workflow executed for a target file. The execution information can include file name information for the executed file. is the file name information can be information indicating the file name of the electronic file. The execution information can include execution date and time information for the executed file. The execution date and time information can be information indicating the execution date and time of the workflow.

The execution information can include execution result information for the executed file. The execution result information can be information indicating the execution result of the workflow. The execution result can include execution success or failure. The execution success or failure can be a success of execution or a failure of execution. A workflow executed for a target file may succeed or fail.

The execution information can include information related to the executed file. The information related to the executed file can be information that can identify the executed file. For example, the information that can identify the executed file can be information indicating the contents of the executed file.

The communication circuit 14 can be an interface for inputting or outputting information or data. The communication circuit 14 can communicably connect the information processing apparatus 1 to other devices via a network NW. The communication circuit 14 can be an example of a communication unit of the information processing apparatus 1.

Note that the hardware configuration of the information processing apparatus 1 is not limited to the above-described configuration. The information processing apparatus 1 can omit and change the above-described components and add new components as appropriate.

Each part implemented by the processing circuit 11 is be described herein.

The processing circuit 11 can implement a first registration unit 111 (e. g., first registrar, etc.), a monitoring unit 112 (e.g., monitor, etc.), an acquisition unit 113 (e.g., acquirer, etc.), a reading unit 114 (e.g., reader, etc.), a second registration unit 115 (e.g., second registrar, etc.), a read-out unit 116 (e.g., retriever, etc.), a comparison unit 117 (e.g., comparer, etc.), and a control unit 118 (e.g., controller). Each part implemented by the processing circuit 11 can also be a function.

The first registration unit 111 can register the storage location information in the storage location information storage area 131. The storage location indicated by the storage location information can be a monitoring destination for monitoring the existence of the target file. The registration of the storage location information in the storage location information storage area 131 can indicate storing the storage location information in the storage location information storage area 131. The first registration unit 111 can be an example of a registration unit that registers the storage location information.

The monitoring unit 112 can confirm existence of the target file at the storage location by monitoring the storage location indicated by the storage location information. For example, in response to the monitoring unit 112 confirming the existence of the target file at the storage location, the monitoring unit notifies the acquisition unit 113 that the target file exists at the storage location.

The acquisition unit 113 can acquire the target file. For example, the acquisition unit 113 can receive a notification from the monitoring unit 112 that the target file exists at the storage location. The acquisition unit 113 can acquire the target file from the storage location where the existence of the target file was confirmed by the monitoring unit 112 based on the notification. The acquisition unit 113 can transmit the acquired target file to the reading unit 114.

The reading unit 114 can read information related to the target file from the target file. For example, the reading unit 114 can receive the target file from the acquisition unit 113. The reading unit 114 can read information related to the target file from the target file acquired by the acquisition unit 113. The reading unit 114 can read file name information related to the target file from the target file. The processing circuit 11 can transmit information related to the read target file to the comparison unit 117. The processing circuit 11 can transmit the file name information for the read target file to the comparison unit 117.

The reading unit 114 can read information related to the target file by any processing such as AI (Artificial (Optical Character Recognition). In Intelligence) or OCR response to the target file being an electronic file indicating an invoice, the information related to the target file may be information indicating a billing source, company name, or the like, similar to the information related to the executed file described above. In response to the target file being an electronic file indicating a purchase order, the information related to the target file may be information indicating an ordering company name or the like, similar to the information related to the executed file described above.

The second registration unit 115 can register the execution information in the execution information storage area 132 when the workflow for the target file is executed. The registration of the execution information in the execution information storage area 132 can indicate storing the execution information in the execution information storage area 132. The second registration unit 115 can be an example of a registration unit that registers execution information.

For example, the second registration unit 115 can receive the execution result information for the target file from the control unit 118. The second registration unit 115 can receive the execution date and time information for the target file from the control unit 118. The second registration unit 115 can receive the information related to the target file from the control unit 118. The second registration unit 115 can receive the file name information for the target file from the control unit 118.

In response to the workflow for the target file being executed, the second registration unit 115 can register the following information in the execution information storage area 132. The second registration unit 115 can register the file name information for the target file in the execution information storage area 132 as the file name information for the executed file. The second registration unit 115 can register the execution date and time information for the target file in the execution information storage area 132 as the execution date and time information for the executed file. The second registration unit 115 can register the execution result information for the target file in the execution information storage area 132 as the execution result information for the executed file. The second registration unit 115 can register the information related to the target file read by the reading unit 114 in the execution information storage area 132 as the information related to the executed file.

The read-out unit 116 can read out (e.g., determine, derive, retrieve, etc.) the information related to the executed file for each executed file stored in the execution information storage area 132, from the execution information storage area 132. For example, the read-out unit 116 can read the information related to the executed file for each executed file from the execution information storage area 132 based on the reading out request from the comparison unit 117. The read-out unit 116 can transmit information related to the executed file for each executed file read out to the comparison unit 117.

The comparison unit 117 can compare the information related to the executed file for each executed file stored in the execution information storage area 132 with the information related to the target file. For example, the comparison unit 117 can receive information related to the target file from the reading unit 114. The comparison unit 117 can receive the file name information related to the target file from the reading unit 114. Upon receiving the information related to the target file, the comparison unit 117 can notify the read-out unit 116 of the reading out request. The comparison unit 117 can receive information related to the executed file for each executed file from the read-out unit 116. The comparison unit 117 can compare the information related to the executed file for each executed file read out by the read-out unit 116 with the information related to the target file read by the reading unit 114. The comparison unit 117 can transmit the comparison result (e.g., results of the comparison unit 117, etc.) to the control unit 118. The comparison unit 117 can transmit the information related to the target file to the control unit 118. The comparison unit 117 can transmit the file name information for the target file to the control unit 118.

The comparison result can be whether the information related to the executed file that is the same as the information related to the target file is stored in the execution information storage area 132. The information related to the executed file that is the same as the information related to the target file can be described as information related to the executed file that exactly matches the information related to the target file, but is not limited thereto. The information related to the executed file that is the same as the information related to the target file may be the information related to the executed file that matches the information related to the target file by a threshold or more. The threshold may be a number or a percentage.

In response to the information related to the target file being the same as the information related to the executed file for any of the executed files, the information related to the executed file that is the same as the information related to the target file is stored in the execution information storage area 132. In response to the information related to the target file being different from the information related to the executed file for any of the executed files, the information related to the executed file that is the same as the information related to the target file is not stored in the execution information storage area 132.

The control unit 118 can control the workflow for the target file based on the comparison result by the comparison unit 117. Controlling the workflow for the target file can include determining execution of the workflow for the target file based on the comparison result by the comparison unit 117. Determining execution of the workflow can be determining that the workflow is to be executed, or determining that the workflow is not to be executed. For example, the control unit 118 can determine whether the information related to the executed file that is the same as the information related to the target file is stored in the execution information storage area 132 based on the comparison result by the comparison unit 117. In response to the information related to the executed file that is the same as the information related to the target file being stored in the execution information storage area 132, the control unit 118 can determine not to execute the workflow for the target file. In response to the information related to the executed file that is the same as the information related to the target file being not stored in the execution information storage area 132, the control unit 118 can determine to execute the workflow for the target file.

The controlling the workflow for the target file can include executing the workflow based on the determination result. The determination result can be that it is determined that the workflow for the target file is to be executed, or that the workflow for the target file is not to be executed. For example, in response to the control unit 118 determining to execute the workflow for the target file, the control unit 118 can execute the workflow for the target file. In response to the control unit 118 determining not to execute the workflow for the target file, the control unit 118 may not execute the workflow for the target file.

The control unit 118 can execute any workflow for the target file. The control unit 118 may select the workflow based on the information associated with the target file and execute the workflow for the target file. The control unit 118 may select the workflow set according to the storage location and execute the workflow for the target file.

The control unit 118 can transmit the following information to the second registration unit 115 after the execution of the workflow for the target file. The control unit 118 can transmit the execution result information for the target file to the second registration unit 115. The control unit 118 can transmit the execution date and time information for the target file to the second registration unit 115. The control unit 118 can transmit the information about the target file to the second registration unit 115. The control unit 118 can transmit the file name information for the target file to the second registration unit 115.

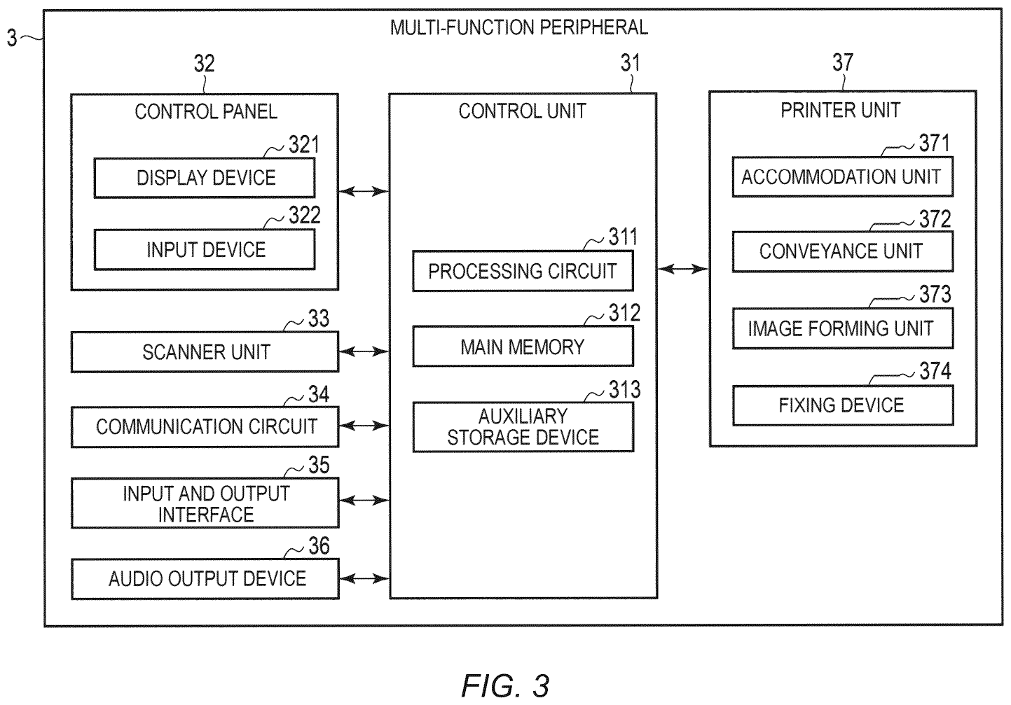

FIG. 3 is a block diagram illustrating a schematic example of the configuration of the multi-function peripheral 3.

The multi-function peripheral 3 can include a control unit 31 (e.g., a controller, etc.), a control panel 32, a scanner unit 33 (e.g., a scanner, etc.), a communication circuit 34, an input and output interface 35, an audio output device 36, and a printer unit 37 (e.g., a printer, etc.). The control unit 31, the control panel 32, the scanner unit 33, the communication circuit 34, the input and output interface 35, the audio output device 36, and the printer unit 37 can be connected to each other to input and output signals.

The control unit 31 can control the operation of each part of the multi-function peripheral 3. The control unit 31 can include a processing circuit 311, a main memory 312, and an auxiliary storage device 313.

The processing circuit 311 can correspond to a central portion of the multi-function peripheral 3. The processing circuit 311 can be a component that constitutes a computer of the multi-function peripheral 3. The processing circuit 311 can include one or more circuits that execute a plurality of processes with a plurality of functions. The processing circuit 311 can load a program stored in the main memory 312 or the auxiliary storage device 313 into the main memory 312. The processing circuit 311 can make various processes executable by executing a program loaded in the main memory 312.

The main memory 312 can correspond to a main storage portion of the multi-function peripheral 3. The main memory 312 can be a component that constitutes a computer of the multi-function peripheral 3. The main memory 312 may be configured in the same manner as the main memory 12.

The auxiliary storage device 313 can correspond to an auxiliary storage portion of the multi-function peripheral 3. The auxiliary storage device 313 may be configured in the same manner as the auxiliary storage device 13. The auxiliary storage device 313 can store the program described above, data used by the processing circuit 311 to perform various processes, and data generated by processing in the processing circuit 311.

The control panel 32 can include a display device 321 and an input device 322.

The display device 321 can be a device capable of displaying an image. The display device 321 can be a liquid crystal display or an organic EL (electroluminescence) display, but is not limited thereto.

The input device 322 can be a device capable of inputting an indication based on a user operation. The input device 322 may include a pressable button. The input device 322 may be a touch panel configured integrally with the display device 321.

The scanner unit 33 can be a device that reads an image such as a character, a shape, and a photo drawn on a medium by scanning the medium placed in a predetermined position. The scanner unit 33 can include a line sensor. The line sensor may be a CCD (Charge Coupled Device) type. The line sensor may be a CIS (Contact Image Sensor) type. The scanner unit 33 can generate image data based on the image read using the line sensor.

The communication circuit 34 can be an interface for inputting or outputting information or data. The communication circuit 34 can communicably connect the multi-function peripheral 3 to other devices via the network NW.

The input and output interface 35 can be an interface for connecting the multi-function peripheral 3 to an external device. The input and output interface 35 can include a connector of the wired cable.

The audio output device 36 can be a device capable of outputting audio by control of the processing circuit 311. For example, the audio output device 36 can be a speaker.

The printer unit 37 can include a unit for printing. The printer unit 37 includes an accommodation unit 371 (e.g., holder, etc.), a conveyance unit 372 (e.g., mover, transmitter, etc.), an image forming unit 373 (e.g., image former, etc.), and a fixing device 374 (e.g., fixer, etc.). The accommodation unit 371 can accommodate sheets. The conveyance unit 372 can convey the sheet in the printer unit 37. The image forming unit 373 can form a toner image on the sheet. The image forming unit 373 can include an intermediate transfer belt, a plurality of developing units (e.g., developers, etc.), an exposure device, a transfer unit, etc. The fixing device 374 can apply heat and pressure to the sheet on which the toner image supplied from the image forming unit 373 is formed. The fixing device 374 can form an image on the sheet by fixing a toner image formed on the sheet by heat and pressure.

Note that the hardware configuration of the multi-function peripheral 3 may not be limited to the above-described configuration. The multi-function peripheral 3 can omit and change the above-described components and add new components as appropriate.

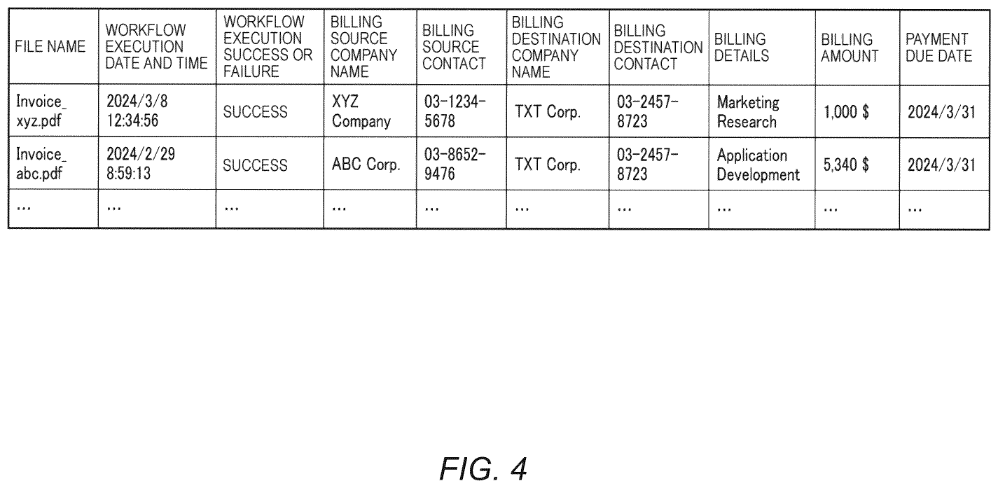

FIG. 4 is a diagram illustrating a data structure of data stored in the execution information storage area 132.

Here, the executed file is assumed to be an electronic file indicating an invoice.

The execution information stored in the execution information storage area 132 can include, by way of example, file name information, execution date and time information, execution result information, and information related to the executed file. The information related to the executed file can include, by way of example, information indicating some or all of the following: the billing source company name, the billing source contact, the billing destination company name, the billing destination contact, the billing details, the billing amount, and the payment due date.

In response to the executed file being an electronic file indicating an invoice, the information related to the executed file can include, by way of example, the following information. The information related to the executed file can include information indicating some or all of the following: the ordering source company name, the ordering source contact, the ordering destination company name, the ordering destination contact, the ordering item name, the unit price of the ordering item, the ordering quantity, the total price, the delivery location, and the delivery time.

### Processing Example

The processing of the information processing system S can be described.

Note that the processing procedures described below are only examples, and each process may be changed as much as possible. Also, for the processing procedures described below, depending on the embodiment, steps can be omitted, replaced, and added as appropriate.

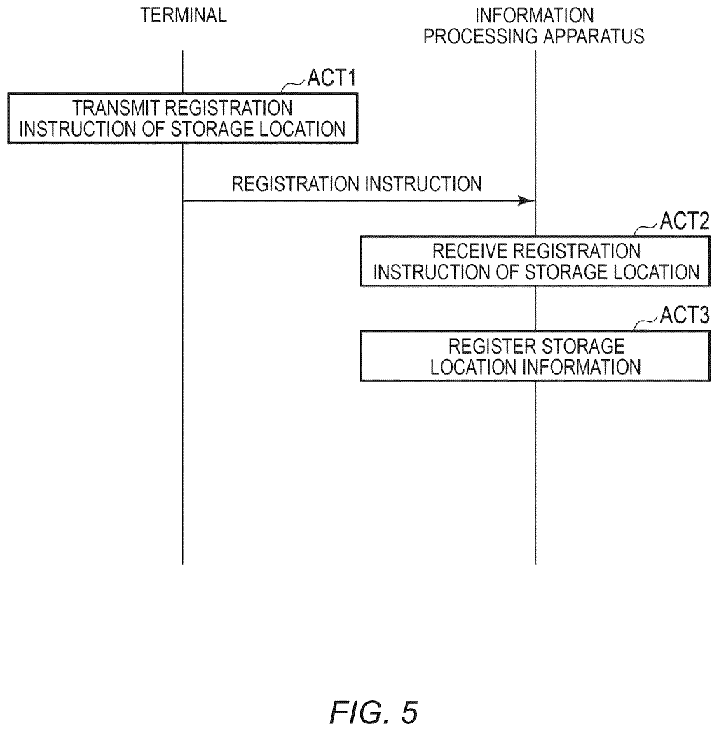

FIG. 5 is a sequence diagram illustrating a registration process of a storage location.

The terminal 4 can transmit a registration instruction of a storage location based on the operation of the user (ACT1). The registration instruction of the storage location can include the storage location information.

The processing circuit 11 of the information processing apparatus 1 can receive the registration instruction of the storage location from the terminal 4 (ACT2).

The processing circuit 11 of the information processing apparatus 1 can register the storage location information based on the registration instruction of the storage location (ACT3). ACT3 may be processed by the first registration unit 111. In ACT3, for example, the processing circuit 11 can register the storage location information in the storage location information storage area 131.

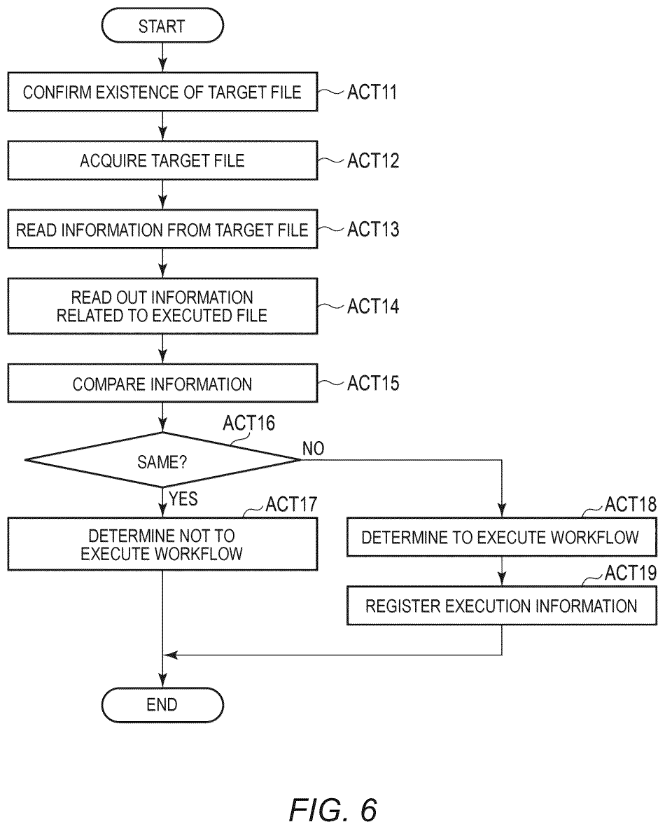

FIG. 6 is a flowchart illustrating control of a workflow by the processing circuit 11 of the information processing apparatus 1.

Here, an example in which the processing circuit 11 controls the workflow for the target file that is present in any storage location is described.

The processing circuit 11 can confirm the existence of the target file at the storage location by monitoring the storage location indicated by the storage location information (ACT11). ACT11 may be processed by the monitoring unit 112.

The processing circuit 11 can acquire the target file (ACT12). ACT12 may be processed by the acquisition unit 113. In ACT12, for example, the processing circuit 11 can acquire the target file from the storage location where the existence of the target file was confirmed.

The processing circuit 11 can read information related to the target file from the target file (ACT13). ACT13 may be processed by the reading unit 114.

The processing circuit 11 can read out the information related to the executed file for each executed file stored in the execution information storage area 132, from the execution information storage area 132 (ACT14). ACT14 may be processed by the read-out unit 116.

The processing circuit 11 can compare the information related to the executed file for each executed file stored in the execution information storage area 132 with the information related to the target file (ACT15). ACT15 may be processed by the comparison unit 117.

The processing circuit 11 can control the workflow for the target file based on the comparison result by the comparison unit 117 as follows. The control of the workflow may be processed by the control unit 118.

The processing circuit 11 can determine whether the information related to the executed file that is the same as the information related to the target file is stored in the execution information storage area 132 based on the comparison result (ACT16). ACT16 may be processed by the control unit 118.

In response to the information related to the executed file that is the same as the information related to the target file being stored in the execution information storage area 132 (ACT16, YES), the process can transition from ACT16 to ACT17. In response to the information related to the executed file that is the same as the information related to the target file being not stored in the execution information storage area 132 (ACT16, NO), the process can transition from ACT16 to ACT18.

The processing circuit 11 can determine not to execute the workflow for the target file (ACT17). ACT17 may be processed by the control unit 118.

The processing circuit 11 can determine to execute the workflow for the target file (ACT18). ACT18 may be processed by the control unit 118. In ACT18, for example, in response to determining to execute the workflow for the target file, the processing circuit 11 can execute the workflow for the target file. The workflow for the target file executed by the processing circuit 11 may succeed or fail.

The processing circuit 11 can register the execution information in the execution information storage area 132 (ACT19). ACT19 may be processed by the second registration unit 115. In ACT19, for example, in response to the workflow for the target file being executed, the processing circuit 11 can register the execution information in the execution information storage area 132 as follows. The processing circuit 11 can register the file name information for the target file in the execution information storage area 132 as the file name information for the executed file. The processing circuit 11 can register the execution date and time information for the target file in the execution information storage area 132 as the execution date and time information for the executed file. The processing circuit 11 can register the execution result information for the target file in the execution information storage area 132 as the execution result information for the executed file. The processing circuit 11 can register the information related to the target file read by the reading unit 114 in the execution information storage area 132 as the information related to the executed file.

Note that in ACT17, in response to the information related to the executed file that is the same as the information related to the target file being stored in the execution information storage area 132, the processing circuit 11 can determine not to execute the workflow for the target file, but is not limited thereto. In response to the information related to the executed file that is the same as the information related to the target file being stored in the execution information storage area 132, the processing circuit 11 may process as follows. For example, the processing circuit 11 cab determine the execution of the workflow for the target file based on the execution result of the workflow for the executed file. The process may be processed by the control unit 118.

In at least one example, the processing circuit 11 can obtain the execution result information from the execution information storage area 132 for the executed file related to the information regarding the executed file that is the same as the information related to the target file. The processing circuit 11 can determine the execution of the workflow for the target file based on the execution result indicated by the execution result information. In response to the execution result being successful, the processing circuit 11 can determine not to execute the workflow for the target file. In response to the execution result being a failure, the processing circuit 11 can determine to execute the workflow for the target file. The processing circuit 11 can execute the workflow based on the determination result.

As described above, the information processing apparatus 1 can compare the information related to the executed file for each executed file with the information related to the target file. The information processing apparatus 1 can control the workflow for the target file based on the comparison result. For example, the information processing apparatus 1 can determine the execution of the workflow for the target file based on the comparison result.

As a result, even if the electronic file having the same contents as the electronic file in which the workflow was executed is stored again in the predetermined storage location, the information processing apparatus 1 may not execute the workflow for the electronic file. As a result, the information processing apparatus 1 can execute the necessary workflow and mitigate the execution of the unnecessary workflow.

As described above, the information processing apparatus 1 can determine the execution of the workflow for the target file based on the execution result of the workflow for the executed file.

As a result, the information processing apparatus 1 can execute the workflow for the electronic file having the same contents as the electronic file in which the executed workflow failed. As a result, the information processing apparatus 1 can execute the necessary workflow and prevent the execution of the unnecessary workflow.

As described above, the information processing apparatus 1 can register the information related to the target file in the execution information storage area 132 as the information related to the executed file.

As a result, the information processing apparatus 1 can accumulate the information related to the executed file used for comparison with the information related to the target file every time the workflow is executed. As a result, the information processing apparatus 1 can execute the necessary workflow and prevent the execution of the unnecessary workflow by using the accumulated information related to the executed file.

As described above, the information processing apparatus 1 can register the execution result information for the target file in the execution information storage area 132 as the execution result information for the executed file.

As a result, the information processing apparatus 1 can accumulate the execution result information used for the execution determination of the workflow for the target file every time the workflow is executed. As a result, the information processing apparatus 1 can execute the necessary workflow and prevent the execution of the unnecessary workflow by using the accumulated execution result information.

### OTHER EMBODIMENTS

Although the above-described embodiment describes the storage location as being set on the auxiliary storage device of the storage device 2, it is not limited thereto. The storage location may be set in the auxiliary storage device 13 of the information processing apparatus 1. The storage location may be set in the auxiliary storage device 313 of the multi-function peripheral 3.

Each part implemented by the processing circuit 11 described in the above-described embodiment may not be limited to being implemented in one device such as the information processing apparatus 1. The respective parts may be implemented in the information processing system S by being distributed across a plurality of devices. In response to the respective parts being implemented in a plurality of servers in a distributed manner, the processing system S may include a plurality of servers.

The above-described embodiments may be applied to a method performed by one or more devices. The above-described embodiments may be applied to a program capable of causing a computer of one or more devices to perform each function. The above-described embodiments may be applied to a storage medium storing a program.

At least one of the one or more circuits (e.g., processors, etc.) that constitute a processing circuit can execute one or more among a plurality of processes. In response to the processing circuit being configured with a single circuit, the single circuit can execute all of the plurality of processes. In response to the processing circuit being configured with a plurality of circuits, at least one of the plurality of circuits can execute a portion of the plurality of processes. A portion of the plurality of processes may be one among the plurality of processes or may be two or more among the plurality of processes. In response to the processing circuit being configured with a plurality of circuits, the plurality of circuits may be included in a single apparatus or may be distributed across a plurality of apparatuses.

The program may be transferred in a state of being stored in the device according to the embodiment, or may be transferred in a state of not being stored in the device. In the latter case, the program may be transferred via a network or may be transferred in a state of being recorded on a recording medium. The recording medium can be a non-transitory tangible medium. The recording medium can be a computer-readable medium. The recording medium may be a CD-ROM, memory card, or any other medium capable of storing the program and readable by a computer, regardless of its form.

While certain embodiments have been described, these embodiments have been presented by way of example only, and are not intended to limit the scope of the disclosure. Indeed, the novel embodiments described herein may be embodied in a variety of other forms; furthermore, various omissions, substitutions and changes in the form of the embodiments described herein may be made without departing from the spirit of the disclosure. The accompanying claims and their equivalents are intended to cover such forms or modifications as would fall within the scope and spirit of the disclosure.

Some embodiments described above may be represented as follows.

(1) An information processing apparatus comprising:
an acquisition unit configured to acquire a target file;
a reading unit configured to read information related to the target file from the target file;
a comparison unit configured to compare information related to an executed file for each executed file for which a workflow was executed stored in the storage unit with information related to the target file; and
a control unit configured to control a workflow for the target file based on the comparison result.

(2) The information processing apparatus according to (1), wherein
the comparison result is whether the information related to the executed file that is the same as the information related to the target file is stored in the storage unit, and
the control unit determines the execution of the workflow for the target file based on the comparison result.

(3) The information processing apparatus according to (2), wherein
if the information related to the executed file that is the same as the information related to the target file is stored in the storage unit, the control unit determines the execution of the workflow for the target file based on the execution result of the workflow for the executed file.

(4) The information processing apparatus according to (1), further comprising a registration unit configured to register the information related to the target file in the storage unit as the information related to the executed file when the workflow for the target file is executed.

(5) An information processing system comprising:
an acquisition unit configured to acquire a target file;
a reading unit configured to read information related to the target file from the target file;
a comparison unit configured to compare information related to an executed file for each executed file for which a workflow was executed stored in the storage unit with information related to the target file; and
a control unit configured to control a workflow for the target file based on the comparison result.

(6) A method of causing a computer to execute:
a function for acquiring a target file;
a function for reading information related to the target file from the target file;
a function for comparing information related to an executed file for each executed file for which a workflow was executed stored in the storage unit with information related to the target file; and
a function for controlling a workflow for the target file based on the comparison result.

What is claimed is:

1. An information processing apparatus comprising:
an acquirer configured to acquire a target file;
a reader configured to read information related to the target file from the target file;
a comparer configured to compare information related to at least one executed file for which a first workflow was executed on stored in a storage with the information related to the target file; and
a controller configured to control a second workflow for the target file based on a comparison result.

2. The information processing apparatus according to claim 1, wherein
the comparison result is whether the information related to the at least one executed file is same as the information related to the target file, and
the controller determines the execution of the second workflow for the target file based on the comparison result.

3. The information processing apparatus according to claim 2, wherein
in response to the information related to the at least one executed file that is the same as the information related to the target file being stored in the storage, the controller determines the execution of the second workflow for the target file based on an execution result of the first workflow for the executed file.

4. The information processing apparatus according to claim 1, further comprising:
a registrar configured to register the information related to the target file in the storage as the information related to the at least one executed file in response to the second workflow for the target file being executed.

5. An information processing system comprising:
an acquirer configured to acquire a target file;
a reader configured to read information related to the target file from the target file;
a comparer configured to compare information related to at least one executed file for which a first workflow was executed on stored in a storage with the information related to the target file; and
a controller configured to control a second workflow for the target file based on a comparison result.

6. The information processing system according to claim 5, wherein
the comparison result is whether the information related to the at least one executed file is same as the information related to the target file, and
the controller determines the execution of the second workflow for the target file based on the comparison result.

7. The information processing system according to claim 6, wherein
in response to the information related to the at least one executed file that is the same as the information related to the target file being g stored in the storage, the controller determines the execution of the second workflow for the target file based on an execution result of the first workflow for the executed file.

8. The information processing system according to claim 5, further comprising:
a registrar configured to register the information related to the target file in the storage as the information related to the at least one executed file in response to the second workflow for the target file being executed.

9. A method, comprising:
acquiring, by one or more processors, a target file;
reading, by the one or more processors, information related to the target file from the target file;
comparing, by the one or more processors, information related to at least one executed file for which a first workflow was executed on stored in a storage unit with the information related to the target file; and
controlling, by the one or more processors, a second workflow for the target file based on a comparison result.

10. The method according to claim 9, wherein
the comparison result is whether the information related to the at least one executed file is same as the information related to the target file, and
the method comprises determining, by the one or more processors, the execution of the second workflow for the target file based on the comparison result.

11. The method according to claim 10, further comprising:
in response to the information related to the at least one executed file that is the same as the information related to the target file being stored in the storage, determining, by the one or more processors, the execution of the second workflow for the target file based on an execution result of the first workflow for the executed file.

12. The method according to claim 9, further comprising:
registering, by the one or more processors, the information related to the target file in the storage as the information related to the at least one executed file in response to the second workflow for the target file being executed.
